(19) United States
(12) Patent Application Publication
(10) Pub. No.: US 2006/0016858 A1
(43) Pub. Date: Jan. 26, 2006

(54) Method of improving quality and reliability of welded rail joint properties by ultrasonic impact treatment

(75) Inventors: Efim S. Statnikov, Birmingham, AL (US); Vladislav Y. Korostel, Severodvinsk (RU); Vladimir Vityazev, Severodvinsk (RU); Oleg V. Korolkov, Severodvinsk (RU)

Correspondence Address: Breiner & Breiner, L.L.C., P.O. Box 19290, Alexandria, VA, 22320-0290, US

(73) Assignee: U.I.T., LLC, Birmingham, AL (US)

(21) Appl. No.: 11/171,352

(22) Filed: Jul. 1, 2005

Related U.S. Application Data
(63) Continuation-in-part of application No. 11/000,219, filed on Dec. 1, 2004.
Application No. 11/000,219 is a division of application No. 10/015,670, filed on Dec. 17, 2001, now Pat. No. 6,843,957.
Application No. 10/015,670 is a division of application No. 09/288,020, filed on Apr. 8, 1999, now Pat. No. 6,338,765.
Application No. 09/288,020 is a continuation-in-part of application No. 09/145,992, filed on Sep. 3, 1998, now Pat. No. 6,171,415.

(51) Int. Cl. A47J 36/02

(52) U.S. Cl. 228/101

(57) ABSTRACT

A method for improving the performance of sections of rails joined together by welding by reworking welded joints utilizing an ultrasonic impact treatment (UIT) process either before welding, during welding, after welding or during repairs of used rails, including treatment of a joint, around a joint and/or length of a rail, in order to increasing fatigue life and/or other properties of welded rail sections is disclosed. The method provides reduction of stress defects and redistribution of internal stress patterns in the vicinity of weld seams of rails. The UIT provides periodic pulse energy impact treatment with surfaces in welded rails to induce internal compression waves inducing a metal plasticity state in the vicinity of the weld seam of the rail or in the rail itself.

### RELATED APPLICATION

This application is a continuation-in-part of U.S. Ser. No. 11/000,219, filed Dec. 1, 2004, entitled ULTRASONIC IMPACT METHODS FOR TREATMENT OF WELDED STRUCTURES, which in turn is a division of U.S. Pat. No. 6,843,957 B2, issued Jan. 18, 2005, which in turn is a division of U.S. Pat. No. 6,338,765, issued Jan. 15, 2002, which in turn is a continuation-in-part of U.S. Pat. No. 6,171,415, issued Jan. 9, 2001.

### FIELD OF INVENTION

The invention relates to an improvement in the performance of sections of rails joined together by welding, such as thermic or thermite welding, e.g., alumothermic welding or copper thermic welding, and such welding processes as arc welding, gas-pressure welding and flash welding, by reworking welded joints utilizing ultrasonic impact treatment (UIT) process either before welding, during welding, after welding or during repairs of used rails, including treatment of a joint, around a joint and/or a length of a rail, by applying UIT by an ultrasonic impact tool in a manual or automatic fashion, continuously or in batches, with the task of increasing the fatigue life and/or other properties of the welded rail sections.

### BACKGROUND OF THE INVENTION

Rails are used to provide a means of transportation for railroads and metro rolling stocks, trams, locomotives, monorails, trolleys and other moveable, rotary and turning structures. The rails must meet various standards and specifications determined by the country of location. The rails may be made of a suitable material and joined in a suitable fashion such as by thermite welding. During thermite welding of rails, the chemical reaction results in thermite steel, which forms a weld having a cast structure. Cracks may occur in the rails during welding due to imperfect fusing as a result of insufficient preheating or too large of a gap between the welded faces. Cracks may also occur due to displaced rail ends. Other defects of welded rails include incomplete penetration and hot crystallization cracks.

Rail joints, such as for overhead traveling cranes and rail car traffic, are often exposed to high duty cycles, high wheel loads and contact stresses. A battered, damaged, broken or separated rail joint can be a serious and costly problem in the transportation industry. Therefore, keeping trains and production cranes operating safely and reliably at efficient rates and at a low maintenance repair time and cost is essential. Accordingly, sound rail conditions are necessary for a successful crane or train operation.

More particularly, many rail problems are caused by joint failure, either being battered, broken and/or separated. Deteriorated rail joints result in high impact loads on the crane/train and support structures, e.g., girders, bridges and building columns. Impact loads have been found to contribute to wheel bearing fractures and broken axles as well as accelerating fatigue cracks in wheel trucks, rail cars and structural members. In addition, other components within the crane/train are subject to failure or damage due to the impact vibration of the crane/train running over defective rail joints.

Many problems created by rail joints are expensive to repair and/or do not have a quick and easy solution. Over the years, various rail joining methods have been employed in order to repair and/or prevent rail cracks and rail joint failure. These rail joining methods include splice bar bolting, electric arc welding, thermite welding, flash butt welding and gas-pressure welding. Of these methods, the thermite welding process is most often used in the rail network due to, among other things, cost advantages. However, the flash butt welding process is being adopted more often for laying down of new rails.

Flash butt welding is a method which provides high quality joints that, in comparison with other joining methods, are the most resistant to breaking. In addition, flash butt welds do not batter out, a common problem experienced with other joining methods. Rails joined by the flash butt welding process represent a condition that is close to a truly continuous rail. The flash butt welding process is an automated process for joining sections of rails. Lengths of rails are aligned by a welding machine which is electrically charged and the ends of the rails are brought together. As the ends touch, an arc is created, melting and welding the ends together without the use of a welding rod. The entire welding process takes approximately 2 to 3 minutes and the resulting joint is strong and uniform and has a low risk of failure.

Obtaining a good weld joint by electric arc welding is a difficult and time consuming procedure often requiring 10 to 12 hours to complete and requiring a highly competent operator. The electric arc welding technique requires a 35° full bevel at the ends of the rail heads, a 35° double bevel on the web and a 35° full bevel on the upper side of the base. Pre-weld alignment of the rails through the weld joint is required to ensure straightness. A ⅛ inch root clearance is normally specified with an 8 by 2 by ¼ inch copper shim centered under the joint opening. The shim serves as a backup plate for the initial weld bead and provides a vertical camber that helps to compensate for contractional distortion which occurs as the weld cools. The rail ends are preheated to 500° F. and maintained at this temperature during welding. Welding of the base, web and head of the rail proceeds sequentially, alternating on both sides. To insure complete weld penetration, it is necessary to take special measures to avoid the entrapment of foreign material, slag, etc. Excess weld material is then removed by grinding followed by post-heating to 700° F. The weld is protected from rain or snow and low ambient temperatures by an insulating blanket. The joint should be allowed to cool as slowly as possible to ambient temperature.

Currently, electric arc welding continues in common use and for certain applications and provides an acceptable joint. However, a battering out effect approximately 3 inches in length is an inherent wear characteristic. Failure to recognize the onset of this condition and taking early corrective action results in deepening of the battered area and consequently, higher impacts when a wheel crosses the joint thereby resulting in breakage.

Splice bar bolting of joints was first used as a repair method and then for rerailing projects. To help reduce the number of required joints, 60 foot rail lengths became the standard length. Initially, cranes/trains run quietly and smoothly over a new bolted joint. However, within a few months the ends become battered and chipped. To smooth out the ride, weld repairs are made. These weld repairs prove to be only a temporary solution and need to be repeated frequently. Other characteristics of a bolted joint also complicate repair activities and lessen its desirability.

Jacking the rail down to close up a gap after cutting out a defect is unsatisfactory because of interference from the splice bar, rail clip and bolts. In addition, rail clips must be removed at the splice bars and bolts loosen and gaps occur between the rail ends. Also, there have been incidents where the rail has broken through at the weakened bolt hole area. Today, it is generally accepted that splice bar bolted joints are not considered acceptable in certain rail applications.

In the thermite welding process of rails, a highly exothermic reaction between aluminum and iron oxides result in the production of molten steel which is poured into a mold around the gap to be welded. The superheated molten metal causes the rails to melt at the edges of the gap to be welded and also acts as the filler metal so that the material from the rails coalesces with and joins the added molten steel as it solidifies to form a weld.

The procedure for thermite welding generally occurs by the rails being cut square and the gap to be welded being prepared within prescribed limits. The edges to be welded are mechanically cleaned with a brush wire or an abrasive tool to remove rust, burs, oxides or greasy contaminations. A long steel straight edge is used to align the running edge of the rail heads. The rail ends are “peaked” to accommodate contraction during solidification and cooling of the thermite steel. If “rising” of the rails is not done, the joint will sag due to differential cooling of the rail head (where more material is available and hence the cooling is slower) and rail foot after cooling. A sagged joint gives bad riding and becomes a maintenance problem of the rail. Such a joint will be subject to larger stresses due to dynamic augment.

Stands for a crucible and torch are then fixed on the railhead, at the appropriate locations, on opposite sides of the welding gap and the height of the torch stand is checked and adjusted by placing the preheating burner or welding torch on it which is then removed and set aside for later use. A set of prefabricated molds of the appropriate rail section is then selected. Molds are placed in a mold shoe, i.e., clamp, seating it properly using luting sand. The placement of the mold should be central over the gap, as otherwise, while pouring the molten metal, one rail end will get more heat than the other and the fusion of the metal at the other rail may not be complete. A slag bowl is attached to the mold shoe to collect the overflowing slag and molten metal during the pouring. A magnesite lined crucible is housed at the correct height and alignment on the swiveling crucible stand. A closing pin is then placed at the bottom over the opening. The head of the pin is covered with about 5 grams of asbestos powder so that it does not melt when it comes in contact with the molten metal and “auto tapping” takes place. A crucible is swung away from the rail and the portion (self-igniting mixture which yields the molten metal) is poured onto the crucible such as heaped in a conical shape.

Using commercial use cylinders and oxygen, the preheating burner or welding torch is lit and the flame is tuned. This torch is placed in its stand which is fixed over the gap and the flame is directed onto the mold through a central opening. The flame heats the rail ends for a specified time for each rail section and the preheating gases is employed. As the preheating is completed, the thermite reaction is initiated by igniting a sparkler and putting it into the crucible. The reaction occurs for a specified time and the slag is allowed to be separated from the molten metal.

Thereafter, the closing pin is tapped from the outside, thus discharging the metal into the top central cavity of the mold. Thereafter the crucible and torch stands are removed. Any excess thermite steel over the head of the rail (head riser) is removed after solidification, but when the metal is still red hot, by either manual chiseling or using hydraulic weld trimmers. The remaining refractory metal is removed and the steel vent risers attached to the collar of the foot of the weld are snapped off. The wedges are then removed and any fastenings that were removed are re-fixed and the railhead is grounded.

In a thermite reaction, aluminum reacts with iron oxides, particularly ferric oxide, in highly exothermic reactions, reducing the iron oxides to free iron, and forming a slag of aluminum oxide. This reaction may be as follows:
3Fe₃O₄+8Al=4Al₂O₃+9Fe (3088° C., 719.3 kCal ↑)
3FeO+2Al=Al₂O₃+3Fe (2500° C., 187.1 kCal ↑)
Fe₂O₃+2Al=Al₂O₃+2Fe (2960° C., 181.5 kCal ↑)

The various iron oxides are used in appropriate proportions so as to get the correct resultant quantity and temperature of molten steel. Approximately equal quantities of molten steel and liquid aluminum oxide are separated at about 2400° C., after a few seconds of the exothermic reaction. The iron obtained from such a reaction is soft and unusable as a weld metal for joining rails. To produce an alloy of the correct composition, alloys like ferro-manganese are added to the mixture along with pieces of mild steel, both as small particles, to allow rapid dissolution in the molten iron, to control the temperature and to increase the “metal recovery”. Complete slag separation in a short time and better fluidity of the molten metal is achieved by adding compounds like calcium carbonate and fluorspar.

Pre-heating the rail ends (to about 1000° C.) is required to help the poured molten metal in washing away the surface oxidation on the rail ends, as otherwise, the molten metal may chill and solidify immediately on coming in contact with cold rail ends, without washing off the surface oxidation.

While thermite welding provides benefits to joining rails, thermite welds can have problems. Problems associated with thermite welds include, but are not limited to, low tensile ductility, low impact toughness, coarse grain dendrite microstructure, inclusion and porosity, developing internal cracks, easy crack propagation, pores being serious defects, sand getting into the weld and fatigue failures. These problems and shortcomings associated with thermite welds are addressed by the present invention.

### SUMMARY OF THE INVENTION

The invention relates to an improvement in the performance of sections of rails joined together by welding, such as thermic or thermite welding, e.g., alumothermic welding, copper thermic welding, and such welding processes as arc welding, gas-pressure welding and flash welding, etc., by reworking welding joints utilizing an ultrasonic impact treatment (UIT) process either before welding, during welding, after welding or during repairs of used rails, including treatment of a joint, around a joint and/or the length of a rail, by applying UIT by an ultrasonic impacting tool in a manual or automatic fashion, continuously or in batches, with the task of increasing fatigue life and/or other properties of welded rail sections.

Reduction, compensation and redistribution of internal stresses and creation of favorable compressive stresses in weld seams of rails are achieved by ultrasonic impact treatment in accordance with the invention. Such results are achieved by periodic pulse energy impact treatment with surfaces in welded rails to induce internal compression waves inducing a metal plasticity state in the vicinity of the weld seam of the rail or in the rail itself.

Thus, in accordance with this invention, an ultrasonic impact technology non-destructive surface treatment step creates states of plasticity in the vicinity of welds in welded rails with compressive wave patterns that relax stresses and introduce a stress gradient pattern significantly strengthening the weld site. The resulting internal gradient micro-structure patterns in the welded rail avoid micro stress concentration boundaries usually centered about the metallic grain structure in the vicinity of welds. This results in welded rails with longer life and higher load bearing capacity. Such UIT treatment steps are useful during initial product manufacture, maintenance operations, and treatments of stress fatigue or catastrophic failure to restore life.

In an embodiment of the invention, a UIT transducer head is spaced on the surface of a welded rail at a distance multiple of one quarter of the length of the ultrasonic wave that creates, within a volume of a weld, ultrasonic and impulse stresses sufficient to relax residual stresses and affect the microstructure of the weld metal and heat-affected zone. The temperature at the weld area varies within a range from the ambient temperature to the molten metal temperature. The ultrasonic transducer head may be movable to ensure the displacement of the node and antinode points of the ultrasonic wave along the welded joint section, or stationary in controlling the location of nodes and antinodes of the ultrasonic wave using, for example, “sweeping” the excitation carrier frequency in the area of resonance dimensions that correspond to the changing multiple frequencies from lower multiple frequencies to higher ones and vice versa. The ultrasonic transducer head is mounted at the surface of a weld or adjacent area; the temperature of the surface may vary from the ambient temperature to the material plasticity temperature. The ultrasonic transducer head moves along the surface of a weld or a heat affected zone, creates in the surface layer a plastic deformation region with favorable compressive stresses and initiates, through said area, in the material an ultrasonic wave that is accompanied by the distribution of ultrasonic stresses and deformations sufficient to relax residual stresses and affect the microstructure of the weld metal and heat-affected zone.

Treating welded joints with ultrasonic impact treatment provides at least one of the following:
increasing toughness, contact strength, resistance to thermal and shrinkage size changes, low cycle and high cycle durability, resistance to corrosion and corrosion fatigue damage, endurance limit under variable loads, and impact resistance;
increasing guaranteed maximum permissible loads for the strength of materials in contrast to actual norms;
providing guaranteed uniformity for fine grain structure in the cross-section of a weld, in a heat affected zone (HAZ), and a weld toe;
increasing yield of weld material in liquid phase;
providing degassed welded material;
optimize heat and mass exchange in the areas of blast cooling at boundaries of a weld due to moving liquid metal from a middle of a molten pool under the effect of ultrasonic impact treatment pulses;
suppressing micro and macro defects in the form of pores, liquidation cracks, unstable phases, intergranule precipitations and damages, and imperfect fusions due to phenomena caused by acting ultrasonic impact treatment pulses;
controlling stresses and structural deformations of the first, second and third kinds;
controlling material properties determined by affecting material deflected mode and grain, sub-grain and mosaic structure;
optimizing a deflected mode of a weld and a HAZ metal in the areas of tensile stresses;
expanding the range of technical parameters and minimizing limitations when preparing a welded joint for welding and during welding based on improved process reliability and joint quality under the ultrasonic impact treatment effect; and
improving the statistical reliability of post-welding heat treatment processes of welded joints and abolishing heat treatment of a welded joint.

### BRIEF DESCRIPTION OF THE DRAWINGS

Referring now to the drawings:

FIG. 1 is a schematic representation of the ultrasonic oscillations of the invention during welding during excitation in the area of a wave stress antinode;

FIG. 2 is a schematic representation of ultrasonic oscillations of the invention during welding during excitation in an area of a travel antinode;

FIG. 3 is a schematic representation of ultrasonic oscillations of the invention during welding during excitation along a profile cross-section;

FIG. 4 is a schematic representation of the ultrasonic impact treatment method of the invention on a rail base joint;

FIG. 5 is a schematic representation of an embodiment of an ultrasonic impact treatment tool of the invention;

FIG. 6 is a schematic representation of mechanized ultrasonic impact treatment of a weld along a weld profile using the tool of FIG. 5;

FIG. 7 is a schematic representation of ultrasonic impact treatment of a weld along a welded joint profile using a manual ultrasonic impact treatment tool;

FIG. 8 is a side view of the weld joint of FIG. 7;

FIG. 9(a) is a schematic representation of a rail that has not been treated with ultrasonic impact treatment having hot cracks;

FIG. 9(b) is a schematic representation of a rail that has not been treated with ultrasonic impact treatment having gas cavities;

FIG. 9(c) is a schematic representation of a rail that has not been treated with ultrasonic impact treatment having pores;

FIG. 9(d) is a schematic representation of a rail that has not been treated with ultrasonic impact treatment having slag inclusions;

FIG. 9(e) is a schematic representation of a rail that has not been treated with ultrasonic impact treatment having faulty fusions;

FIG. 10(a) is a schematic representation of a rail that has been welded with ultrasonic impact treatment showing the elimination of the hot cracks of FIG. 9(a);

FIG. 10(b) is a schematic representation of a rail that has been welded with ultrasonic impact treatment showing the elimination of the gas cavities of FIG. 9(b);

FIG. 10(c) is a schematic representation of a rail that has been welded with ultrasonic impact treatment showing the elimination of the pores of FIG. 9(c);

FIG. 10(d) is a schematic representation of a rail that has been welded with ultrasonic impact treatment showing the elimination of the slag inclusions of FIG. 9(d);

FIG. 10(e) is a schematic representation of a rail that has been welded with ultrasonic impact treatment showing the elimination of the faulty fusions of FIG. 9(e);

FIG. 11 is a diagram of a rail showing fatigue crack initiation sites;

FIGS. 12(a) and 12(b) show a cross-section of a rail showing a treated area between a weld filler material and the base metal and a heat affected zone on a rail material next to the treated area;

FIG. 13 shows an underside of a rail base treated with ultrasonic impact treatment;

FIG. 14 shows a detail of the rail base of FIG. 13 treated with ultrasonic impact treatment;

FIG. 15 shows a detail of a rail web treated with ultrasonic impact treatment;

FIG. 16 shows a detail of a rail head treated with ultrasonic impact treatment;

FIG. 17 shows a MTS test machine which is used to perform fatigue tests on rails;

FIG. 18 shows a schematic view of fatigue tests conducted on the MTS test machine of FIG. 17;

FIG. 19 shows a side view of a rail of Sample 1 having a direction of fracture;

FIG. 20 shows an underside of a rail (base) of Sample 1 showing a direction of fracture;

FIG. 21 shows an end view of a rail of Sample 1 showing a fracture surface;

FIG. 22 shows a detail of the fracture surface near the underside of the rail base of FIG. 21;

FIG. 23 shows a side view of a rail of Sample 2 showing a direction of fracture;

FIG. 24 shows a bottom view of the rail (base) of FIG. 23 showing a direction of fracture;

FIG. 25 shows an end view of a rail of Sample 2 showing an overview of a fracture surface;

FIG. 26 shows a detail of a fracture initiation near the underside of the rail base of FIG. 25;

FIG. 27 shows a side view of a rail (base) of Sample 3 showing a direction of fracture;

FIG. 28 shows an end view of a rail of Sample 3 showing a fracture surface;

FIG. 29 shows a detail of a fracture initiation area of the rail of FIG. 28;

FIG. 30 is a chart summary of the results of fatigue tests for Samples 1-3 of FIGS. 19-29;

FIG. 31 is a cross-section of a thermite weld at an underside of a rail base;

FIG. 32 shows a transition area from a weld to a base at the rail base on an underside of the weld at the rail base (left) of FIG. 31;

FIG. 33 shows a transition area from a weld to a base at the rail base on an underside of the weld at a rail base (right) after fracture of FIG. 31;

FIG. 34 shows a detail at a higher magnification of the boxed area of FIG. 32;

FIG. 35 shows a detail at a higher magnification of the boxed area in FIG. 33;

FIG. 36 shows a detail of the deformation in the boxed area of FIG. 34 at a higher magnification showing the maximum deformation depth as a result of UIT treatment of 100 μm; and

FIG. 37 shows a detail of the deformation in the boxed area of FIG. 35 at a higher magnification showing the maximum deformation depth as a result of UIT treatment of 80 μm.

### DETAILED DESCRIPTION OF THE PREFERRED EMBODIMENTS

The invention relates to an improvement in the performance of sections of rails joined together by welding, such as thermic or thermite welding, e.g., alumothermic welding or copper thermic welding, and such welding processes as arc welding, gas-pressure welding and flash welding, by reworking welded joints utilizing an ultrasonic impact treatment (UIT) process either before welding, during welding, after welding or during repairs of rails, including treatment of a joint, around a joint and/or the length of a rail, by applying ultrasonic impact treatment an ultrasonic impacting tool in a manual or automatic fashion, continuously or in batches, with the task of increasing a fatigue life and/or other properties of welded rail sections.

Reduction, compensation and redistribution of internal stresses and creation of favorable compressive stresses in weld seams of rails are achieved by ultrasonic impact treatment in accordance with the invention. Such results are achieved by periodic pulse energy impact treatment with surfaces in welded rails to induce internal compression waves inducing a metal plasticity state in the vicinity of the weld seam of the rail or in the rail itself.

Applied pulse energy creates compression waves within the rail in a manner creating a tapered gradient stress pattern between a weld junction and a base site in the rail. This removes stress defects and unpredictable or uncontrolled stress patterns that reduce overall product load bearing capabilities and introduce zones susceptible to failure and fatigue. For optimum effectiveness the impact treatment is preferably ultrasonically induced.

In general, this invention corrects prior art deficiencies by reworking the internal micro structure of the welded rails in various phases of production, maintenance and repair to relax and redistribute structural stress patterns in the vicinity of a weld or in the rail itself. This procedure eliminates or minimizes critical stress patterns or concentrations that reduce life and load bearing capabilities of the rail. Thus, the application of the ultrasonic impact technology afforded by this invention replaces several prior art technical operations and serves to improve the load bearing capabilities of the welded rail and the reduction of stress concentration centers that lead to fatigue, stress corrosion and catastrophic failure.

Thus, in accordance with this invention, an ultrasonic impact technology non-destructive surface treatment step creates states of plasticity in the vicinity of welds in welded rails with compressive wave patterns that relax stresses and introduce a stress gradient pattern significantly strengthening the weld site. The resulting internal gradient micro-structure patterns in the welded rail avoid micro stress concentration boundaries usually centered about the metallic grain structure in the vicinity of welds. This results in welded rails with longer life, higher load bearing capacity and increased resistance to wear. Such UIT treatment steps are useful during initial product manufacture, maintenance operations, and treatments of stress fatigue or catastrophic failure to restore life.

In the technical operation of repair of a defect, such as a crack, the invention is characterized by the basic method steps of UIT treatment as supplemented by the mechanical deformation steps of chamfering sharp edges and the additional steps of welding bracing structures onto the welded rail as a further vehicle for relaxing internal residual stress defects and influencing dynamics of crack formation and development. In an embodiment of the invention, a UIT transducer head is spaced on the surface of a welded rail at a distance multiple of one quarter of the length of the ultrasonic wave that creates, within a volume of a weld, ultrasonic and impulse stresses sufficient to relax residual stresses and affect the microstructure of the weld metal and heat-affected zone. The temperature at the weld area varies within a range from the ambient temperature to the molten metal temperature. The ultrasonic transducer head may be movable to ensure the displacement of the node and antinode points of the ultrasonic wave along the welded joint section, or stationary in controlling the location of nodes and antinodes of the ultrasonic wave using, for example, “sweeping” the excitation carrier frequency in the area of resonance dimensions that correspond to the changing multiple frequencies from lower multiple frequencies to higher ones and vice versa. The ultrasonic transducer head is mounted at the surface of a weld or adjacent area; the temperature of the surface may vary from the ambient temperature to the material plasticity temperature. The ultrasonic transducer head moves along the surface of a weld or a heat affected zone, creates in the surface layer a plastic deformation region with favorable compressive stresses and initiates, through said area, in the material an ultrasonic wave that is accompanied by the distribution of ultrasonic stresses and deformations sufficient to relax residual stresses and affect the microstructure of the weld metal and heat-affected zone.

Thus, the invention provides a nondestructive deformation method of treating a rail to increase its load bearing life and strength at the time of initial welding requiring a minimum of steps or technical operations, including: inducing pulse impact energy nondestructively at the exterior surface or weld or joint of a rail in the vicinity of a seam being welded at a site on the rail exterior surface, preferably employing ultrasonic periodic impact energy of a frequency and magnitude, inducing a temporary plasticity zone internally in the rail induced by internal compression wave patterns near to and inclusive of the welded seam junction thereby to rearrange internal crystalline structure of the rail to produce a patterned grain structure with weld seam junction at the rail surface constituting a substantially grainless white layer leading into a stress gradient pattern directed toward an inner base point in the rail. The resulting grain structure gradient is substantially devoid of internal micro-stress centers that tend to concentrate at grain boundaries and thus eliminates significant grain boundary stress center micro-defects over the gradient range which remains in the rail after the ultrasonic wave energy is removed and the associated temporary plastic state is terminated.

In this manner illustrated by the aforesaid embodiment, the invention provides a novel method of treating a rail during the initial production process, during welding, after welding, or during repairs of used rails to increase its load bearing life and strength, which has other advantages, features and embodiments as hereinafter detailed in connection with the embodiments of the invention.

The invention also encompasses a method of repairing catastrophic failures such as fractures or cracks in the rails. Furthermore, the repair methods, while using a minimum of specialty tooling, are instrumental in relaxing internal residual stress in the crack area, creating by plastic deformation zones of enhanced strength properties, reducing defects and concentrators of internal microstructure stresses, forming favorable compression stress regions in a boundary layer near a crack and adjacent welded seam junctions, creating gradient stress patterns extending from weld seams into the rail to thereby reduce external and internal stresses in welded joints of the rail, and reducing or preventing further crack development and stress fatigue failure in the post-treatment utility life of the rails. By further destructive removal of sharp edge structure along the crack and crack-end stress centers additional significant extensions of renewed life expectancy and reduced stress fatigue are also achieved.

The method of the invention also provides ways of increasing current limiting norms based on the use of ultrasonic impact treatment as a means of controlling the state and the properties of a welded joint governed by specified reliability criteria. Reliability criteria include the following mechanical characteristics of a welded joint: yield strength, ultimate strength, impact strength, and fatigue resistance (which is evaluated based on the fatigue limit at number of cycles specified by the customer). This criteria may be used for (a) local ultrasonic impact treatment on a weld and a heat affected zone; (b) remote ultrasonic impact treatment from a weld at resonance of low frequency oscillations of a welded joint along a rail length and in the cross-section thereof initiated with ultrasonic pulses in the areas of stress and travel antinode; or (c) remote ultrasonic impact treatment for cold metal during welding or with normalized heating up after welding depending on working conditions. The UIT procedures can be implemented by using a hand, portable and/or mechanized ultrasonic impact treatment tool as detailed hereafter.

The method of the invention provides ways of increasing result consistency and minimizing the result scatter as a means of guaranteeing predetermined quality and reliability of a welded joint under conditions of constantly growing loads on railroads based on the ultrasonic impact treatment procedures above. It is common knowledge that in standard tests, the scatter of the results is up to 60%. The scatter after UIT does not exceed 15%.

Treating thermite welded joints and rails with the ultrasonic impact treatment in accordance with the invention improves the characteristics and/or properties of the welds, joints and rails and/or provides new characteristics and/or properties of the welds, joints and rails, as detailed hereafter. The improved and/or new characteristics and/or properties may be obtained before welding, during welding, after welding and/or during repair of the rails. Additionally, these improved and/or new properties of a welded joint or rail provide for expanding the application of thermite welding and other types of welding using ultrasonic impact treatment to manufacture and service rails, not only to repair weld joints. The improved and/or new properties of a welded joint that is treated with ultrasonic impact treatment may include, but are not limited to, having fine grains and good uniformity of grains in a weld, a heat affected zone (HAZ), a weld toe, sorbite structures and bainite structures, and elimination of defects such as hot cracks, gas cavities, pores, slag inclusions and faulty fusions. Additionally, other properties of a base material of a rail being treated with ultrasonic impact treatment in combination with thermite welding or other types of welding of the rail include increased impact strength, contact strength, resistance to thermal and shrinkage size variations, low cycle and high cycle strength, resistance corrosion and corrosion-fatigue damage, fatigue limit under variable loads and impact resistance and an increase of guaranteed maximum allowable loads at a level of material strength as comparable with current norms.

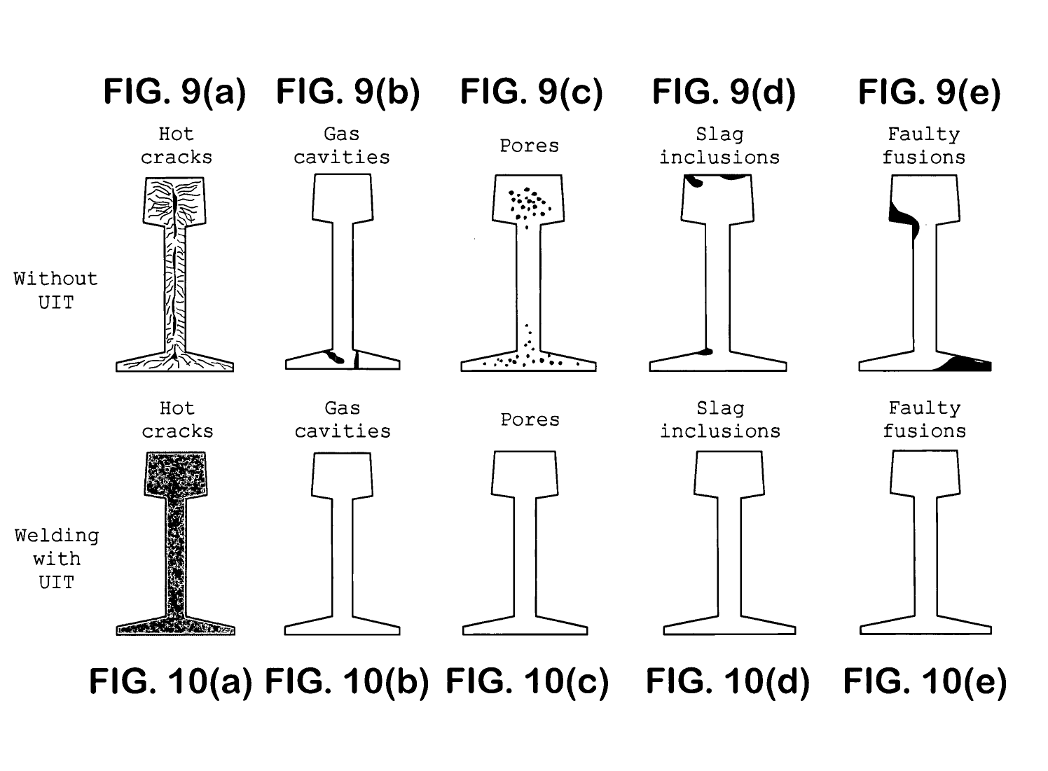

Improved and new structural properties of welded joints achieved by applying ultrasonic impact treatment to thermic welds and the area surrounding the welds also include, but are not limited to: improved yield of a weld material in a liquid phase; optimized heat and mass exchange in an area of blast cooling at boundaries of a weld due to moving liquid metal from the middle of a molten pool under the effect of ultrasonic impact treatment pulses; and suppression of micro and macro defects in the form of pores, liquidation cracks, unstable phases, intergranule precipitations and damages and imperfect fusion caused by acting ultrasonic impact treatment pulses. Examples of weld defects are shown in FIGS. 9(a)-9(e) and FIGS. 10(a)-10(e) show minimization of these defects with the use of welding with ultrasonic impact treatment.

The method of the invention also provides control of stresses and structural deformations of the first, second and third kinds and control of material properties governed by affect on its stress deformed state and structure at the level of grains, sub-grains and mosaic blocks. The effects listed above are the result of the direct action of the varied ultrasonic impact whose mode is set depending on the task. The controlled parameters include the amplitude and frequency of ultrasonic transducer oscillations under load, the mode and parameters of the rebound depending on the properties of a treated material.

The method of the invention also provides an optimized deflected mode of weld metal and a HAZ in the areas of acting tensile stresses (1) in the cross-section of a welded joint and on its surface; (2) in the areas of stress concentrations in welded joint metal and the surface, on the rail head, wall and foot and edges thereof in the regions of fillets between elements; (3) in the transition areas between weld and HAZ metal and between HAZ and rail base metal, and (4) on repaired locations.

Additionally, the method of the invention provides expanded range of technical parameters and minimize limitations when preparing a welded joint for welding and during welding based on improved process reliability and joint quality under the ultrasonic impact treatment effect. The technical parameters (more precisely, requirements) include: (a) the requirements to joint preparation for welding: gap, perpendicularity of edges, beveling; (b) the welding conditions: heat input (current and voltage for arc welding), speed, electrode diameter, temperature of preliminary and concurrent heating; and (c) welding consumables: type, chemical composition, amount of welding consumables per unit length or unit volume of a weld. The improved process reliability implies the probability of providing stable reproducible performance of production objects with minimum scatter of physical-mechanical properties-of a welded joint. The improved process reliability is achieved through the possibility of fine control of the process parameters that are responsible for attaining predetermined performance of an object.

The method also provides improving the statistical reliability of post-welding heat treatment processes of welded joints and also abolishing heat treatment of a welded joint having specific material properties and specific ratios between cross-section areas of elements thereof based on the procedures of ultrasonic impact treatment of the invention.

The method provides a means of quality control of the welding joint during welding and ultrasonic impact treatment. The method provides using a back-striction signal to provide active control during ultrasonic impact treatment of changing material condition and meeting the specification thereof based on analyzing amplitude and frequency characteristics as compared with the reference values for high quality. The method implies the use of the back magnetostriction signal for in-process control (during UIT) over the material condition change and the conformity of the material to the normative requirements based on the analysis of the amplitude-frequency characteristics in comparison with the characteristics of the high-quality reference samples manufacturing process. Various process induced irregularities in a welded joint and occurring during welding change the amplitude-frequency characteristics of the back magnetostriction signal. The results of comparison between the characteristics and those of high-quality reference samples is recorded during the process in real time and used for in-process control. The active control provides generating signals managing the ultrasonic impact treatment parameters to maximum approach to reference values for high quality, thereby resulting in the active control and management of the process during ultrasonic impact treatment, thereby replacing the passive control after processing.

In accordance with the method of the invention, to evaluate and predict the state of a rail welded joint in service, a mobile acoustic monitoring system is used. This system employs a signal of the rail response, at the weld area, to the normalized impact. Mathematical processing of the parameters of the above-mentioned signal and comparison with the results, obtained after the first UIT pass over a welded joint and/or recorded in manufacturing a high-quality reference sample, allow for predicting the rail state or inspecting its conformity to the current standards.

With the method of the invention, evaluation and prediction of welded rail joint condition while the rail is in service is possible. This is accomplished by a portable implementation of the method of the invention based on using a response signal from the rail in the weld to a normalized impact and mathematical processing of weld properties as compared with the results obtained after initial ultrasonic impact treatment of the welded joint and/or the parameters of a reference signal for high quality. The response signal is the oscilloscope picture or digital description of the oscilloscope picture for the transducer reverse magnetostriction voltage. The form of the oscilloscope picture or the digital description thereof is caused by the response of the treated surface to the ultrasonic normalized impact. The signal has an informational function about the state of the treated object. The parameters of a reference signal reflect the values that correspond to the response signals obtained from high quality reference samples or standard joints after manufacturing thereof for further monitoring.

Some defects associated with welded rails include introduced compressive stresses or relaxation of tensile stresses, a presence of inner defects, the granularity according to the internal friction criterion expressed with Q-factor and surface hardness. These characteristics can be easily identified by back striction parameters. The main back striction signal parameters include the frequency, amplitude, phase and damping factor.

Treating thermite welded joints with ultrasonic impact treatment provides at least one of the following:
increasing toughness, contact strength, resistance to thermal and shrinkage size changes, low cycle and high cycle durability, resistance to corrosion and corrosion fatigue damage, endurance limit under variable loads, and impact resistance;
increasing guaranteed maximum permissible loads for the strength of materials in contrast to actual norms;
providing guaranteed uniformity for fine grain structure in the cross-section of a weld, in a HAZ, and a weld toe;
increasing yield of weld material in liquid phase;
providing degassed welded material;
optimize heat and mass exchange in the areas of blast cooling at boundaries of a weld due to moving liquid metal from a middle of a molten pool under the effect of ultrasonic impact treatment pulses;
suppressing micro and macro defects in the form of pores, liquidation cracks, unstable phases, intergranule precipitations and damages, and imperfect fusions due to phenomena caused by acting ultrasonic impact treatment pulses;
controlling stresses and structural deformations of the first, second and third kinds;
controlling material properties determined by affecting material deflected mode and grain, sub-grain and mosaic structure;
optimizing a deflected mode of a weld and a HAZ metal in the areas of tensile stresses;
expanding the range of technical parameters and minimizing limitations when preparing a welded joint for welding and during welding based on improved process reliability and joint quality under the ultrasonic impact treatment effect; and
improving the statistical reliability of post-welding heat treatment processes of welded joints and abolishing heat treatment of a welded joint.

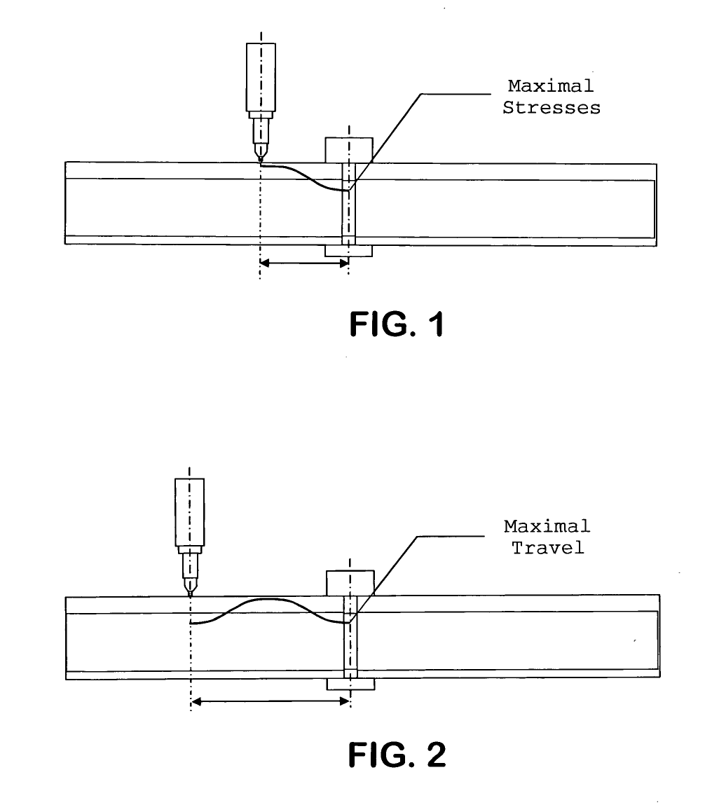

As shown in FIGS. 1-3, ultrasonic oscillations of the invention are introduced into a rail during or after welding. Ultrasonic impact treatment is preferably performed on cold metal, during welding or after welding with normalized heating up depending on working conditions. FIG. 1 shows ultrasonic oscillations on a rail during excitation in the area of wave stress antinode. FIG. 1 shows a schematic representation of the excitation of ultrasonic oscillations of a rail at carrier frequency of the ultrasonic transducer under condition of superposition between stress waves and the weld area. To excite ultrasonic oscillations of a rail, the ultrasonic impact tool is positioned perpendicularly to a rail at a distance equal or multiple of the first quarter of the ultrasonic wave from the axial section of a welded joint.

FIG. 2 shows ultrasonic oscillations of a rail in the travel antinode region during excitation of a rail during welding. In so doing, the ultrasonic impact tool is positioned perpendicularly to a rail.

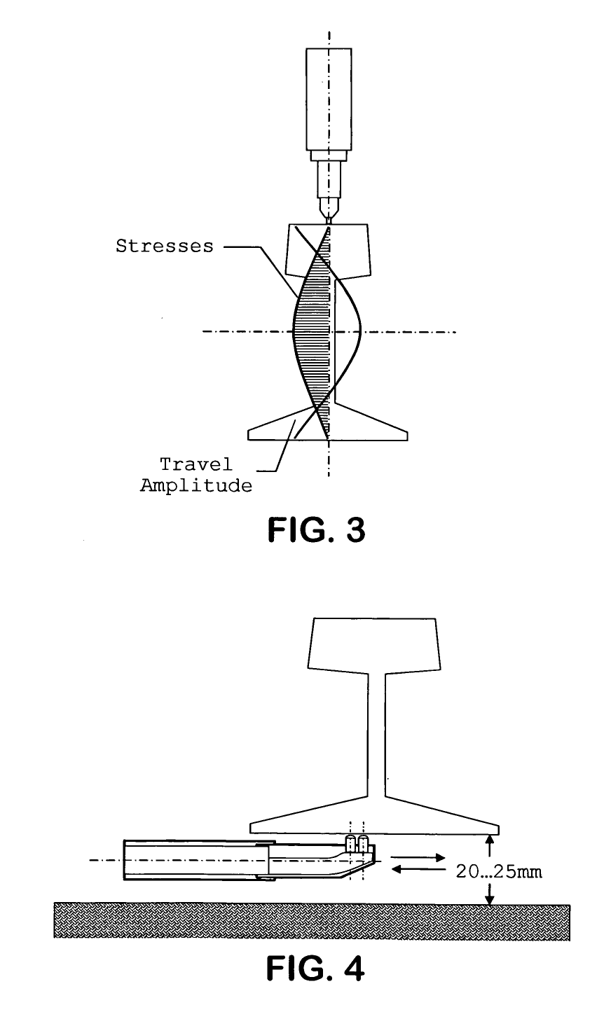

FIG. 3 shows ultrasonic oscillations on a rail during welding during excitation along a profile cross-section of the rail. FIG. 3 shows the distribution of ultrasonic stresses and ultrasonic displacement amplitude in a cross-section of a rail in a direction perpendicular to the rail axis from the rail head to the rail base when the tool is mounted on the rail head. The maximum displacement amplitude corresponds to the section points located on the rail head and rail base surfaces. The maximum ultrasonic stress corresponds to the area of minimum displacements (or nodes), which in this case occur in the rail base. However, it is possible to control the location of nodes and antinodes of the ultrasonic wave by, for example, “sweeping” the excitation frequency in the multiple resonance area from lower multiple frequencies to higher ones and vice versa.

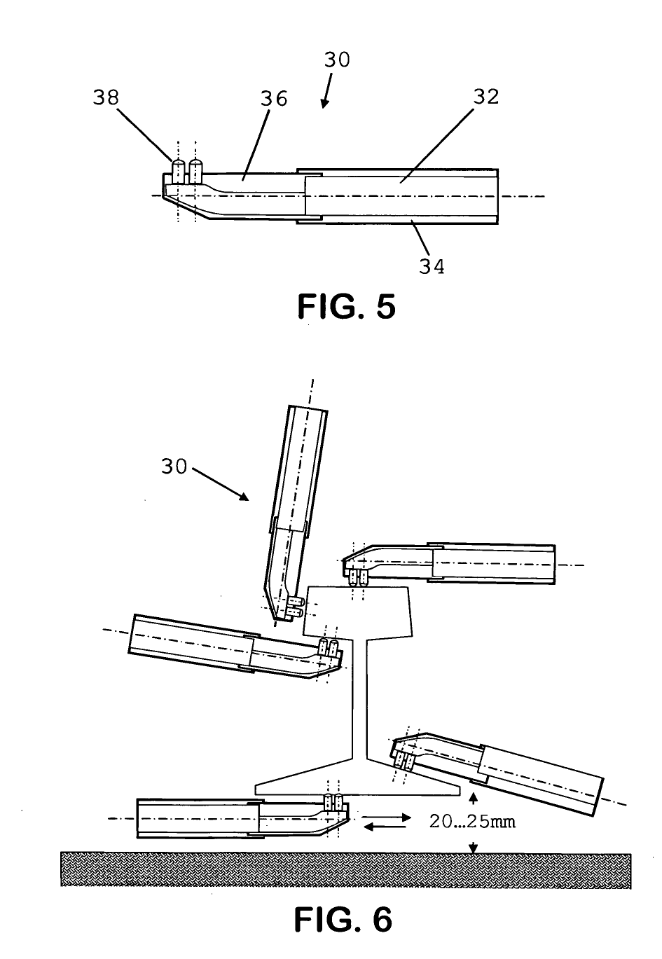

Ultrasonic impact treatment of a thermite welded rail base joint in accordance with the invention is shown in FIG. 4. The ultrasonic impact treatment of a rail is preferably performed on a cold metal or after welding with normalized heating up depending on working conditions. FIG. 5 shows a preferred ultrasonic impact treatment tool for use in ultrasonic impact treatment in accordance with the invention. The ultrasonic impact tool 30 preferably comprises a transformer of vibration velocity direction-waveguide 32, a pin holder bracket 34, a pin holder 36 on a first end of the waveguide 32 which connects to the waveguide 32 by the pin holder bracket 34. A free end of the pin holder 36 preferably has at least one indenter 38 thereon. The tool may be used manually, positioned on a trolley or other suitable type car which may be movable along the rails. The ultrasonic impact treatment of the invention may take place while the trolley is fixed in place or moving along the rails.

FIG. 6 shows an embodiment of mechanized ultrasonic impact treatment of a weld along a weld profile of a rail using the ultrasonic impacting tool 30.

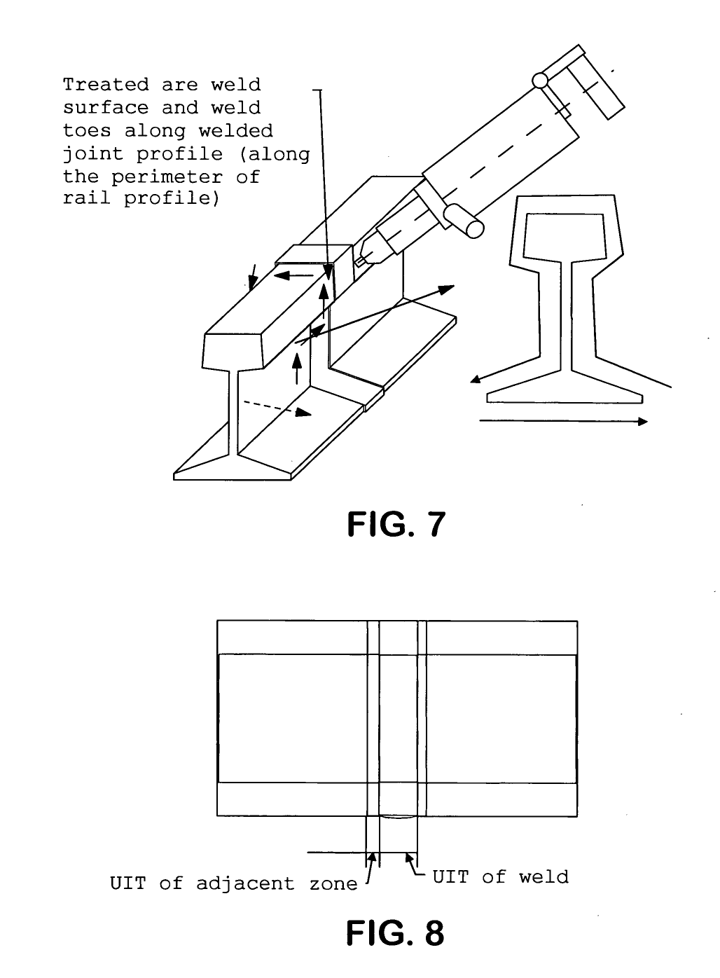

FIG. 7 shows an embodiment of manual ultrasonic impact treatment along a welded joint profile of a rail using a manual ultrasonic impact tool. The treatment is performed on a cold metal or after welding with normalized heating up depending on working conditions. The weld surface and weld toes along the welded joint profile (along the perimeter of the rail profile) are treated with ultrasonic impact treatment. FIG. 8 shows a side view of the welded area of the rail. As shown, the weld area is treated with ultrasonic impact treatment along with the area adjacent to the weld.

FIGS. 9(a)-9(e) show some defects that may occur in rails without ultrasonic impact treatment including hot cracks, gas cavities, pores, slag inclusions, and faulty fusions, respectively. FIGS. 10(a)-10(e) show the weld defects of FIGS. 9(a)-9(e) minimized after welding and ultrasonic impact treatment including the elimination or minimization of hot cracks, gas cavities, pores, slag inclusions and faulty fusions, respectively.

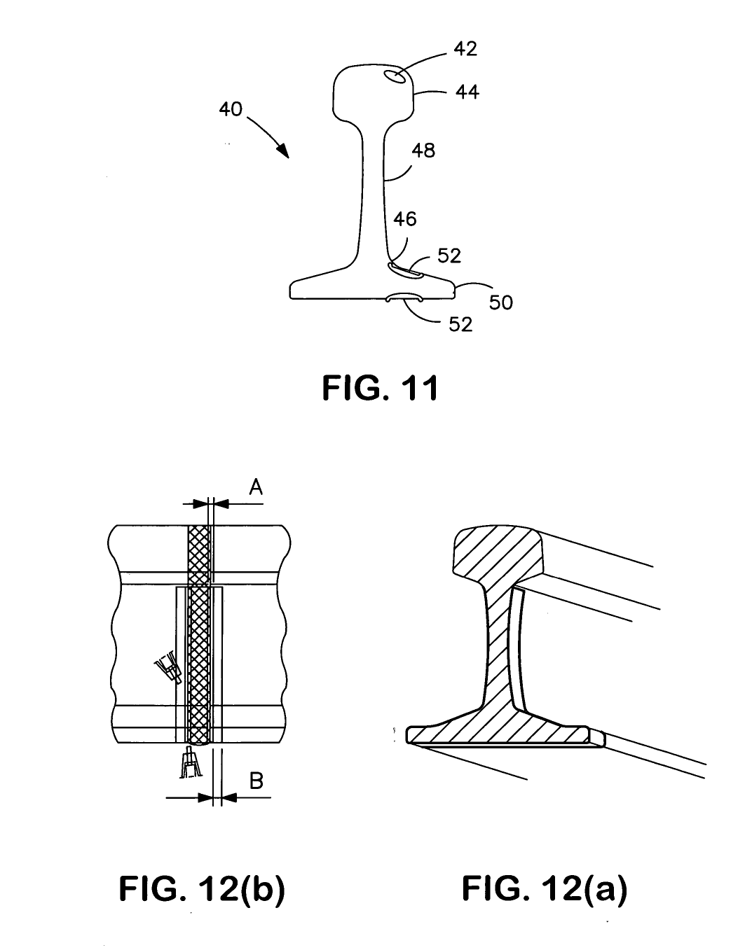

Most of the failures of the weld occur due to fatigue or inclusions in the weld. The fatigue failure most often occurs at the weld toe at the fillet in the web and the area at the underside of the rail. FIG. 11 shows fatigue crack initiation sites on a rail 40. The rail 40 has a rail head 44, a rail web 48, a rail base 50 and a web-to-base fillet 46 between the rail web 48 and the rail base 50. The rail 40 has an internal fatigue crack 42 on the rail head 44, a fatigue crack 52 at the weld toe in the fillet 46 and a fatigue crack 52 at the weld toe in the base 50.

The rails may be treated after manufacturing thereof, before or after assembly in the field, as a part of maintenance and damage prevention, after extensive wear, or at any other suitable period.

Tests were conducted in two phases to determine the fatigue life improvement of a thermite weld using ultrasonic impact treatment on a rail. Phase 1 was an initial test of a sample treated with UIT on the base, web and head to get an indication of the approximate increase in fatigue life—initial sales test. The standard requirement for fatigue life of a thermite weld is no less than 2 million cycles under the loads and test program as described hereafter. The sample was treated with ultrasonic impact treatment at the junction of the base material and the weld material for a distance of 15 mm in the HAZ of the base material on both sides of the weld. The ultrasonic impact treatment was done all around the rail including the rail head, rail web and rail base. The initial test result of the UIT treated specimen went to 5 million cycles and the test was stopped. The sample did not fail.

In Phase 2, three specimens were manufactured and then treated with UIT as described herein. In Phase 2, only the base of the rail and the web area were treated. The treatment zone was the junction of the base material and the weld material for a distance of 15 mm of the HAZ of the base material on both sides of the weld. As shown in FIGS. 12(a) and 12(b), the treated area is shown as the faying zone “A” between the weld filler material and the base metal and the HAZ zone “B” which has a width of about 10 mm to about 15 mm on the base rail material immediately next to zone “A”.

In the invention, any suitable ultrasonic impact system may be used. However, the tests above used a portable ultrasonic impact treatment system which has a hand tool with a 1 Kw system having an amplitude of 26 microns when not loaded. The frequency of the tool was 27 kHz and the power setting was full power. For the indenters, a standard 3 mm radius and 25 mm length needles were used.

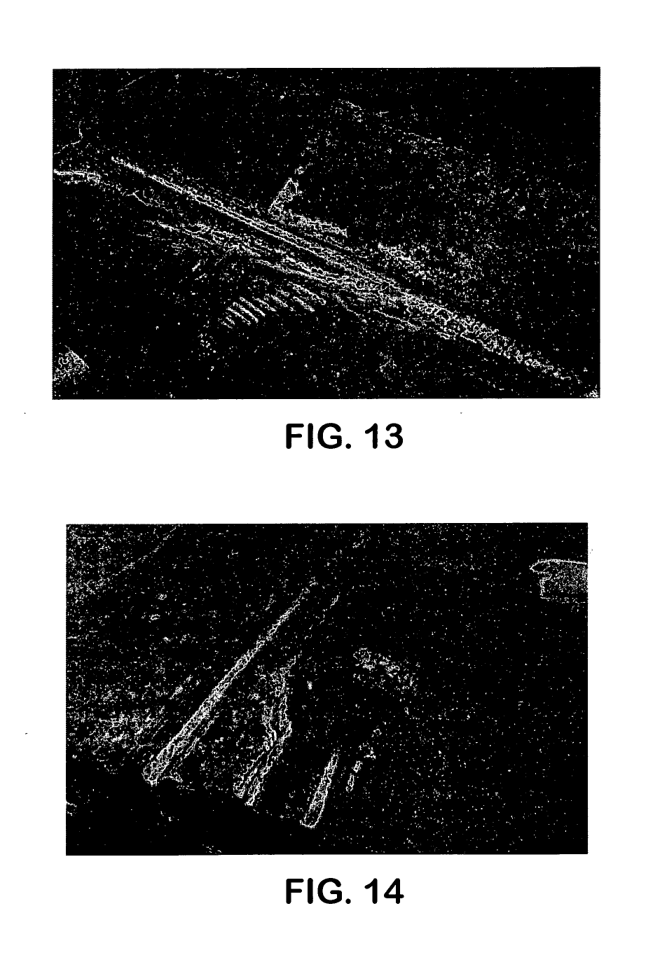

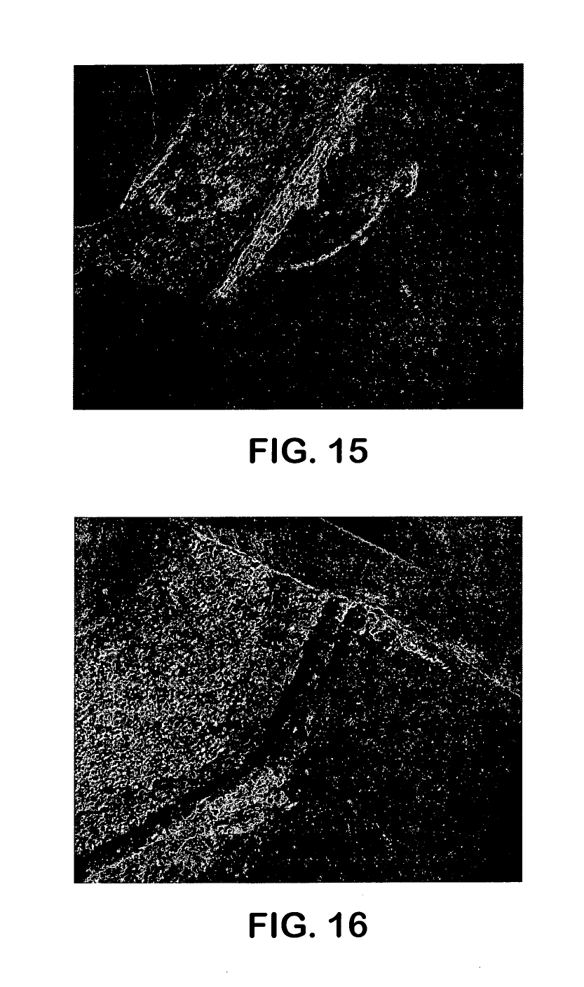

The test welds were visually examined after treating with ultrasonic impact treatment. FIGS. 13 and 14 show the underside of a treated rail base. FIG. 15 shows the treated rail web and FIG. 16 shows the underside of the treated rail head.

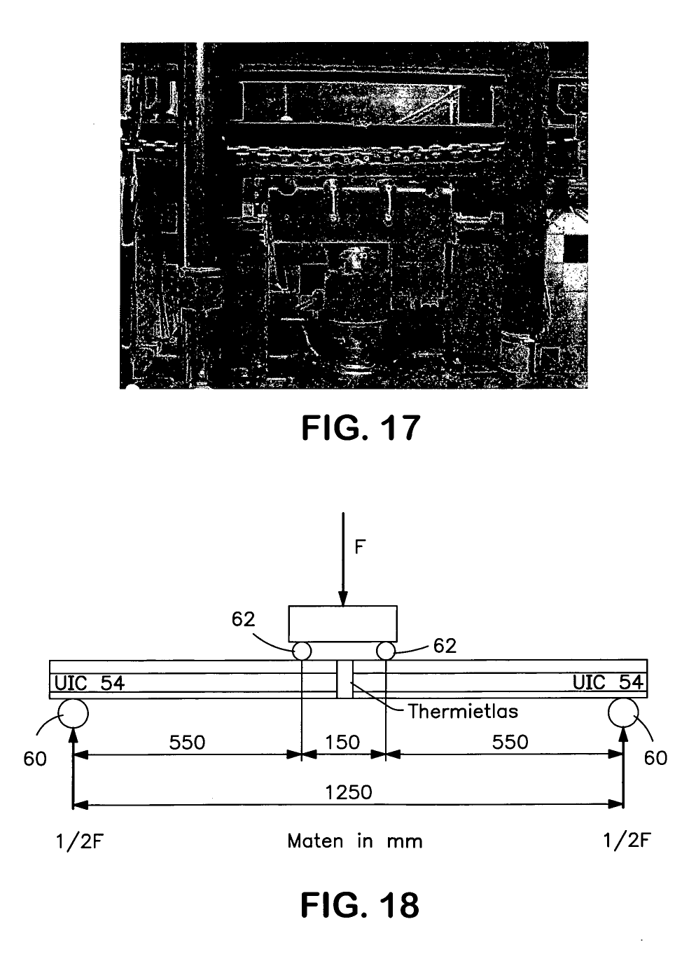

Fatigue tests of the treated rails were then performed. As shown in FIG. 17, a 750 kN MTS test machine was used to perform 4-point fatigue-bend tests on the treated rails. As shown in FIG. 18, the distance between the support rollers 60 on the test machine was 1250 mm and the distance between the pressure rollers 62 was 150 mm. However, any suitable test machine having any suitable distance between the support rollers and between the pressure rollers may be used. The rail base of the rail was exposed to tensile stresses during the testing.

The test was performed with stress ranges on the underside of the rail base between +20 and +200 MPa (stress amplitude 180 MPa), at a frequency of 8 Hz. The samples ran to 5.19 million cycles without failure. At this time, the stress range was increased to a stress amplitude of 200 MPa (+20 MPa to +220 MPa). The stresses were calculated with a resistance moment of 313,000 MPa. Tests were performed to conform with the standard and guidelines of the European Acceptance Program.

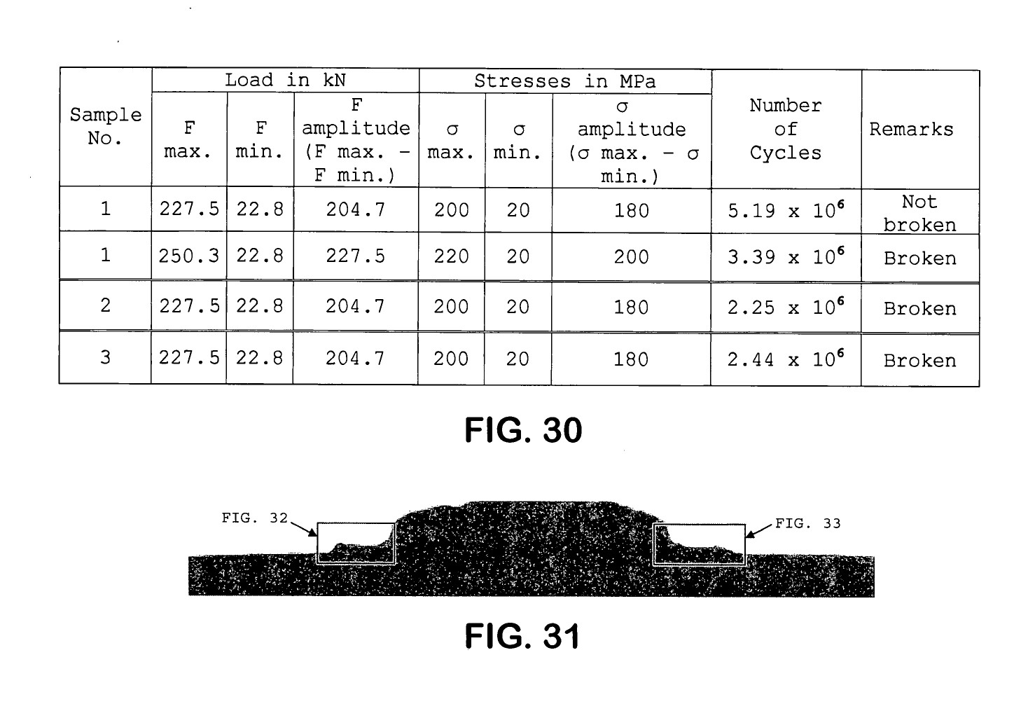

An overview of the results of the fatigue tests are shown in FIG. 30 and detailed hereafter.

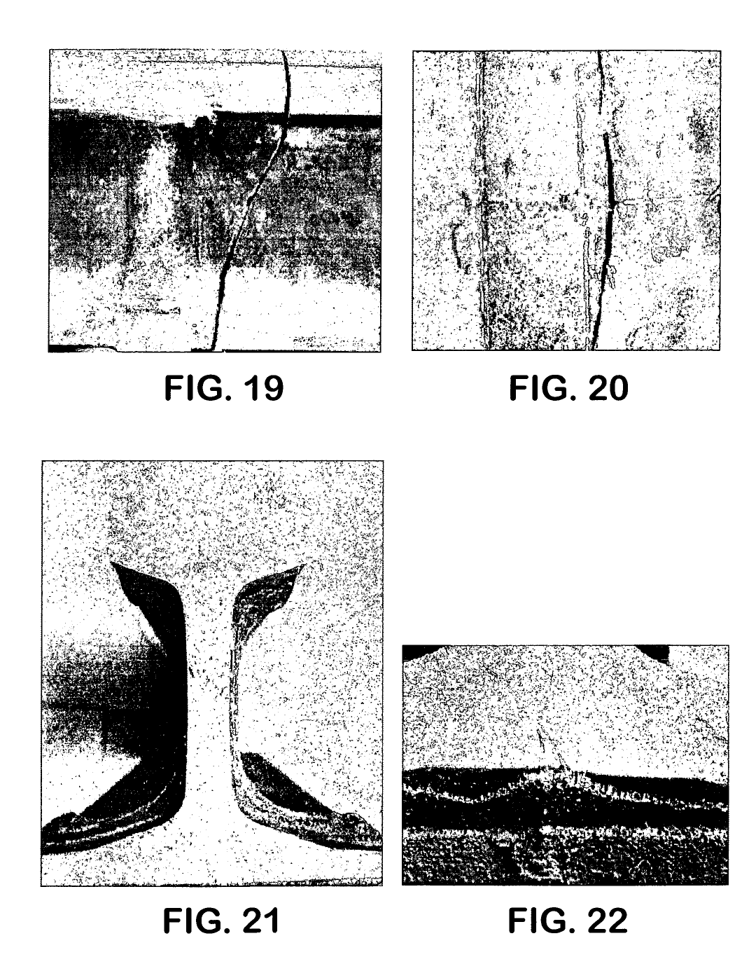

Sample No. 1 shows no crack or damage after 5.19×10⁶ cycles at a stress amplitude of 180 MPa. After increasing the amplitude to 200 MPa, the sample was broken after an additional 3.39×10⁶ cycles at this amplitude. The fracture of this sample initiated at the “over blousing” (bulges out the limits of the rail) of excessive weld metal caused by the thermite welding process at the underside of the rail base. The fracture direction of Sample No. 1 is shown in FIGS. 19 and 20 and the fracture surface of Sample No. 1 is shown in FIGS. 21 and 22.

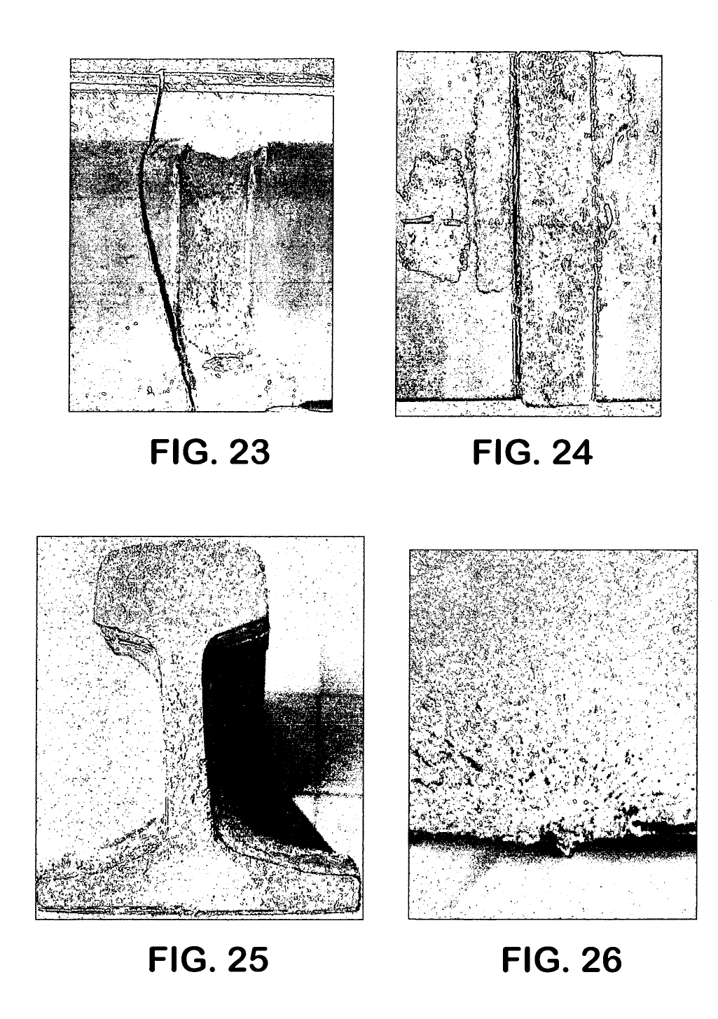

Sample No. 2 was broken after 2.25×10⁶ cycles at a stress amplitude of 180 MPa. The fracture initiated at an inclusion (a sand grain) at the underside of the rail base. The fracture direction of Sample No. 2 is shown in FIGS. 23 and 24 and the fracture surface of Sample No. 2 is shown in FIGS. 25 and 26.

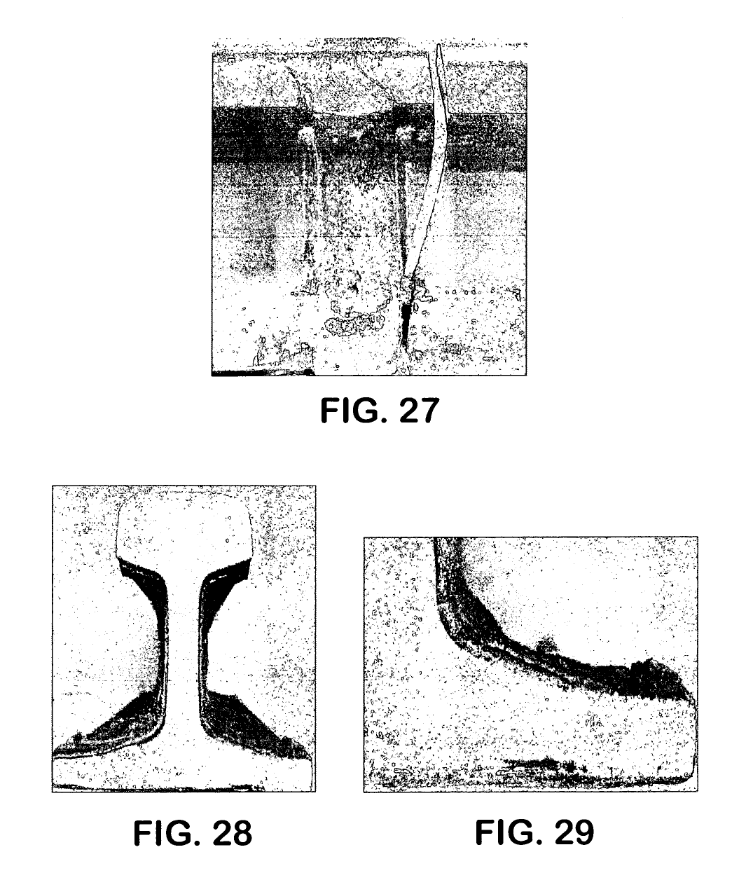

Sample No. 3 was broken after 2.44×10⁶ cycles at a stress amplitude of 180 MPa. The fracture initiated at an inclusion as a result of the thermite welding process at the upper side of the rail base. The fracture direction of Sample No. 3 is shown in FIG. 27 and the fracture surface of Sample No. 3 is shown in FIGS. 28 and 29.

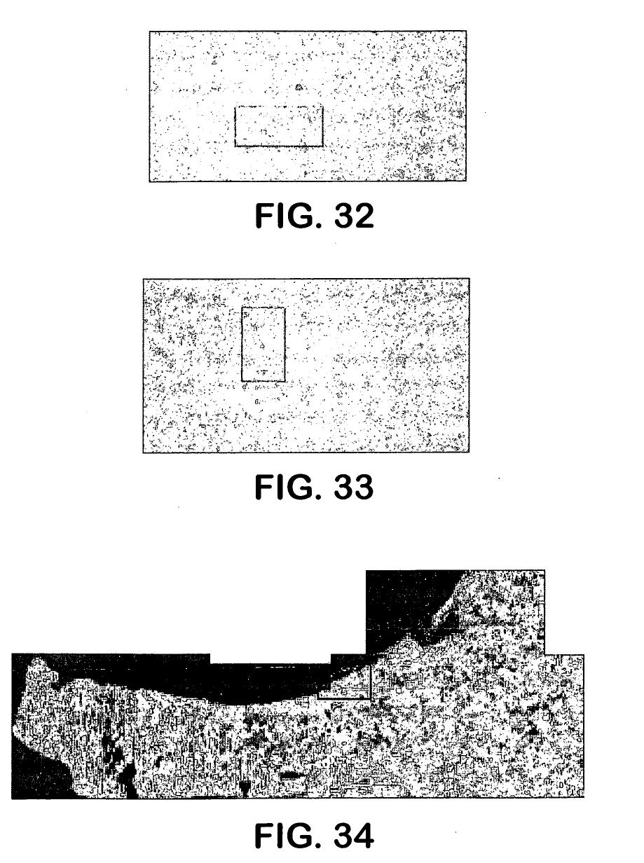

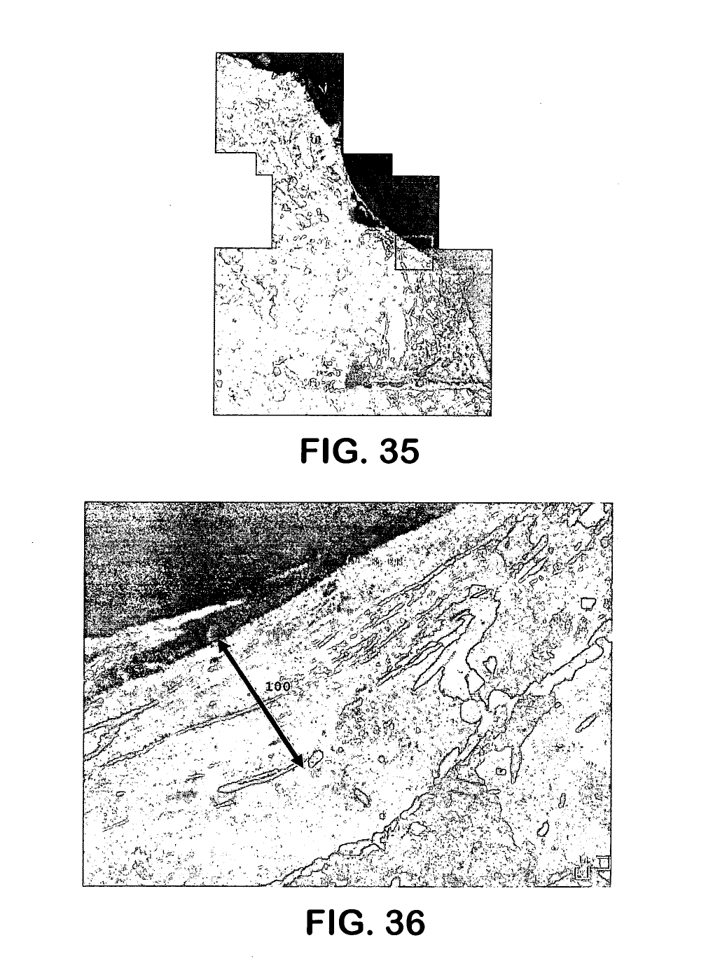

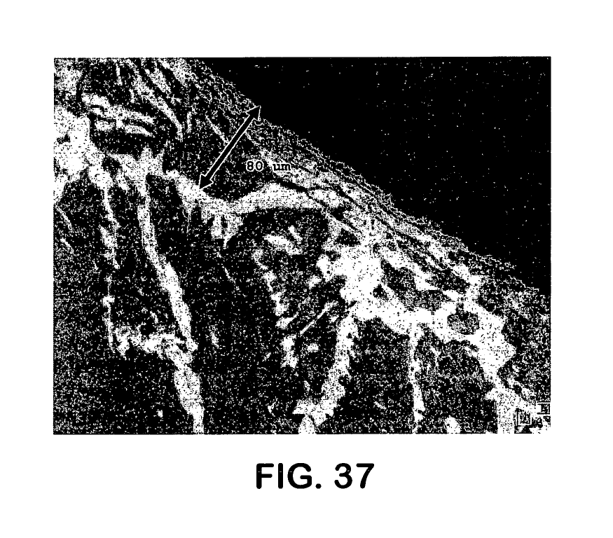

A cross-section was taken out of the rail base of Sample No. 2 for microscopic examination. The examination concentrated on the transition area between weld metal and the heat affected zone of the base material. The results of the examination are shown in FIGS. 31-37. FIG. 31 shows the cross-section of a thermite weld at an underside of the rail base. FIG. 32 shows the transition area from the weld to the base material at the rail base on an underside of the weld at the rail base (left) of FIG. 31, showing plastic deformation of the UIT treated area as well as the “over bloused” excessive weld metal. FIG. 33 shows the transition area from the weld to the base material at the rail base on an underside of the weld at the rail base (right) after fracture of FIG. 31. FIG. 34 shows a detail at a higher magnification of the boxed area of FIG. 32. FIG. 35 shows a detail at a higher magnification of the boxed area of FIG. 33. FIG. 36 shows a detail of the deformation in the boxed area of FIG. 34 at a higher magnification showing the maximum deformation depth as a result of ultrasonic impact treatment of 100 μm. FIG. 37 shows a detail of the deformation in the boxed area of FIG. 35 at a higher magnification showing the maximum deformation depth as a result of ultrasonic impact treatment of 80 μm. Generally, the depth of visible deformation during microscopic examination is between 50 μm and 100 μm.

As a result of testing, Sample No. 1 did not break at the prescribed stress amplitude of 180 MPa after 5.19×10⁶ cycles. Only after increasing the stress amplitude to 200 MPa, the specimen fractured after running an additional 3.39×10⁶ cycles. Sample Nos. 2 and 3 respectively fractured after 2.25×10⁶ and 2.44×10⁶ cycles at the prescribed stress amplitude of 180 MPa. Both of the samples failed due to inclusions in the weld. The specification calls for 2×10⁶ cycles at a stress load amplitude of 180 MPa, which was achieved by both of these samples. Under normal, untreated conditions, i.e., without ultrasonic impact treatment, historical data has conclusively shown that samples with inclusions in weld would have failed well before 1.5×10⁶ cycles.

Even with weld defects, due to ultrasonic impact treatment according to the invention, the desired criteria of 2×10⁶ can be achieved.

As will be apparent to one skilled in the art, various modifications can be made within the scope of the aforesaid description. Such modifications being within the ability of one skilled in the art form a part of the present invention and are embraced by the appended claims.

It is claimed:

1. A method of modifying or producing at least one predetermined property in a rail by impulse treatment to attain at least one technical effect in the rail comprising:
treating at least a portion of a rail with ultrasonic impact treatment; and
attaining at least one technical effect in said rail by said ultrasonic impact treatment.

2. The method of claim 1, wherein said at least one technical effect of said ultrasonic impact treatment is at least one of:
increasing toughness, contact strength, resistance to thermal and shrinkage size changes, low cycle and high cycle durability, resistance to corrosion and corrosion fatigue damage, endurance limit under variable loads, and/or impact resistance;
increasing guaranteed maximum permissible loads for the strength of materials in contrast to actual norms;
providing guaranteed uniformity for fine grain structure in the cross-section of a weld, in a HAZ, and/or a weld toe;
increasing yield of weld material in liquid phase;
providing degassed welded material;
optimize heat and mass exchange in the areas of blast cooling at boundaries of a weld due to moving liquid metal from a middle of a molten pool under the effect of ultrasonic impact treatment pulses;
suppressing micro and macro defects present as pores, liquidation cracks, unstable phases, intergranule precipitations and damages, and/or imperfect fusions due to phenomena caused by acting ultrasonic impact treatment pulses;
controlling stresses and structural deformations of the first, second and third kinds;
controlling material properties determined by affecting material deflected mode and grain, sub-grain and mosaic structure;
optimizing a deflected mode of a weld and a HAZ metal in areas of tensile stresses;
expanding technical parameters and minimizing limitations when preparing a welded joint for welding and during welding based on improved process reliability and joint quality under the ultrasonic impact treatment effect; and
improving statistical reliability of post-welding heat treatment processes of welded joints and abolishing heat treatment of a welded joint.

3. The method of claim 1, wherein said at least one technical effect of said ultrasonic impact treatment is at least one of:
fine grains and good uniformity of grains in a weld, a heat affected zone, a weld toe, sorbite structures and/or bainite structures;
elimination of defects including hot cracks, gas cavities, pores, slag inclusions and/or faulty fusions;
increased impact strength, contact strength, resistance to thermal and shrinkage size variations, low cycle and high cycle strength, resistance corrosion and corrosion-fatigue damage, and/or fatigue limit under variable loads and impact resistance;
increased guaranteed maximum allowable loads at a level of material strength as comparable with current norms;
improved yield of a weld material in a liquid phase;
optimized heat and mass exchange in an area of blast cooling at boundaries of a weld due to moving liquid metal from a middle of a molten pool under an effect of ultrasonic impact treatment pulses; and
suppression of micro and macro defects including pores, liquidation cracks, unstable phases, intergranule precipitations and damages and imperfect fusion caused by acting ultrasonic impact treatment pulses.

4. The method of claim 1, wherein treating said at least said portion of said rail with ultrasonic impact treatment occurs before, during or after welding or joinder of said at least said portion of said rail.

5. The method of claim 1, wherein said at least said portion of said rail treated with ultrasonic impact treatment is a weld.

6. The method of claim 1, wherein said at least said portion of said rail treated with ultrasonic impact treatment is a rail head, a rail base or a rail web.

7. The method of claim 1, wherein said at least said portion of said rail is treated after manufacturing thereof, before or after assembly in an area of use, as part of maintenance and damage prevention or after extensive wear.

8. The method of claim 1, wherein said ultrasonic impact treatment is provide by a tool.

9. The method of claim 8, wherein said tool may be a mechanized tool or a manual tool.

10. The method of claim 8, wherein said tool is positioned on a trolley which is movable along said rail during said ultrasonic impact treatment.

11. The method of claim 8, wherein said tool is positioned on a trolley which is stationary along said rail during said ultrasonic impact treatment.
